(19) United States
(12) Patent Application Publication
(10) Pub. No.: US 2006/0101499 A1
(43) Pub. Date: May 11, 2006

(54) Method and system for secure sharing, gifting, and purchasing of content on television and mobile devices

(75) Inventors: Murali Aravamudan, Windham, NH (US); Ajit Rajasekharan, West Windsor, NJ (US)

Correspondence Address: WILMER CUTLER PICKERING HALE AND DORR LLP, 60 STATE STREET, BOSTON, MA, 02109, US

(73) Assignee: Veveo, Inc., Andover, MA (US)

(21) Appl. No.: 11/270,382

(22) Filed: Nov. 9, 2005

Related U.S. Application Data
(60) Provisional application No. 60/626,274, filed on Nov. 9, 2004.

(51) Int. Cl. H04N 7/173; G06F 13/00; H04N 5/445; G06F 3/00

(52) U.S. Cl. 725/86; 725/87; 725/45; 725/46

(57) ABSTRACT

A method and system are provided for secure sharing and purchasing of content on television and mobile devices, where a user, while viewing or listening to content can, with a simple interface, send a link to a sample time slice of the content to another user (or group of users) with optionally annotating the content in real-time or in a time-shifted manner. The shared clip segment can then be used as an incentive for the content to be purchased by the other user or optionally gift it to another user. Furthermore, during the sharing process, the user may engage in a live conversation with recipients who are viewing the shared content segment. The system can enable the user to additionally bookmark any segment of interest, which could be shared subsequently with other users. This experience of real-time or time-shifted sharing of content segments enables the user to approximate a living room or group viewing experience across people who are geographically separated and/or using different rendering devices.

### CROSS REFERENCE TO RELATED APPLICATIONS

This application claims benefit of the following patent application, assigned to the assignee of the present application and which is incorporated by reference herein in its entirety: Ser. No. 60/626,274 filed on Nov. 9, 2004 and entitled “Television Systems and Associated Methods.”

### BACKGROUND OF THE INVENTION

The present invention relates to a system and method for secure sharing and purchasing of content on television and mobile devices, where a user, while viewing or listening to content, can with a simple interface, send a sample (link or copy) of the content to another user with optionally annotating the content in real-time or in a time-shifted manner.

Efforts have been underway for over a decade on the personal computer world to facilitate secure digital content sharing. Digital rights management systems have been design to facilitate the notion of “super distribution” where a secure digital copy could be distributed by a user to any person or group of persons. These sharing systems have been designed for a personal computer based sharing framework where the user interface relied on a full-fledged QWERTY keyboard coupled with a typical computer display for proximate viewing and interaction.

The recent growth of broadband for television and wireless networks has not only increased the choice of content for these media, but has opened up options for richer interactivity and content sharing options. However, the methods popular on personal computer based sharing networks do not directly translate to television and cell phones due to the limitation of user input capabilities and the display constraints. (FIG. 1, e.g., illustrates a typical user input interface for a television or mobile device, which comprises a keypad overloaded with text characters.) Attempts to directly map personal computer based applications to the television world have enjoyed very little success due to these key limitations. Furthermore, these attempts have failed to realize that the television watching is primarily a passive experience, though users would typically like to have greater control over the choice of content. Hence any interaction behavior that is being added to the television should resemble the “real living room” type group viewing experience, enhancing it in ways that do not detract from the group viewing experience.

Broadband wireless networks such as EVDO are opening doors for newer and richer media experiences not possible before. They are also transforming use of cell phones from purely personal devices to devices that can be used for a group experience even away from the living room. Here again, addressing the user experience, the limitation of the user input and display constraints should be recognized in order for new media based applications to become successful and ubiquitous. While ring tones sharing has become a popular activity among the younger population, true secure media sharing has yet to be realized.

Hence there is a need for a method and system that can provide a generally seamless user experience for users to securely view and share content on television and wireless networks where users can be collectively involved in a real-time or time-shifted group viewing experience.

### SUMMARY OF EMBODIMENTS OF THE INVENTION

In accordance with one or more embodiments of the invention, a method and system are provided for secure sharing and purchasing of content on television and mobile devices, where a user, while viewing or listening to content can, with a simple interface, send a link to a sample time slice of the content to another user (or group of users) with optionally annotating the content in real-time or in a time-shifted manner. The shared clip segment can then be used as an incentive for the content to be purchased by the other user or optionally gift it to another user. Furthermore, during the sharing process, the user may engage in a live conversation with recipients who are viewing the shared content segment. The system can enable the user to additionally bookmark any segment of interest, which could be shared subsequently with other users. This experience of real-time or time-shifted sharing of content segments enables the user to approximate a living room or group viewing experience across people who are geographically separated and/or using different rendering devices.

These and other features and advantages of the present invention will become readily apparent from the following detailed description, wherein embodiments of the invention are shown and described by way of illustration of the best mode of the invention. As will be realized, the invention is capable of other and different embodiments and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF DRAWINGS

FIG. 1 illustrates a text input interface comprising a keypad with overloaded keys in accordance with the prior art.

FIG. 2 illustrates a secure content sharing system in accordance with one or more embodiments of the invention being used in a wide range of network configurations.

FIG. 3 is a flow chart illustrating the flow for secure content sample sharing in a television network in accordance with one or more embodiments of the invention.

### DESCRIPTION OF THE PREFERRED EMBODIMENTS

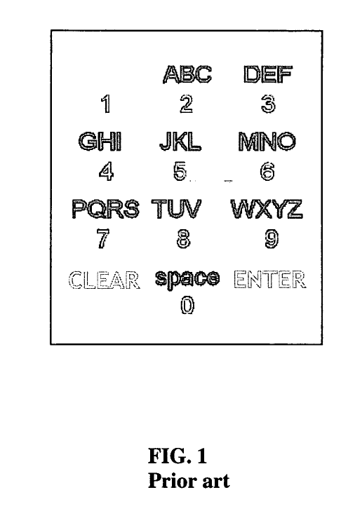

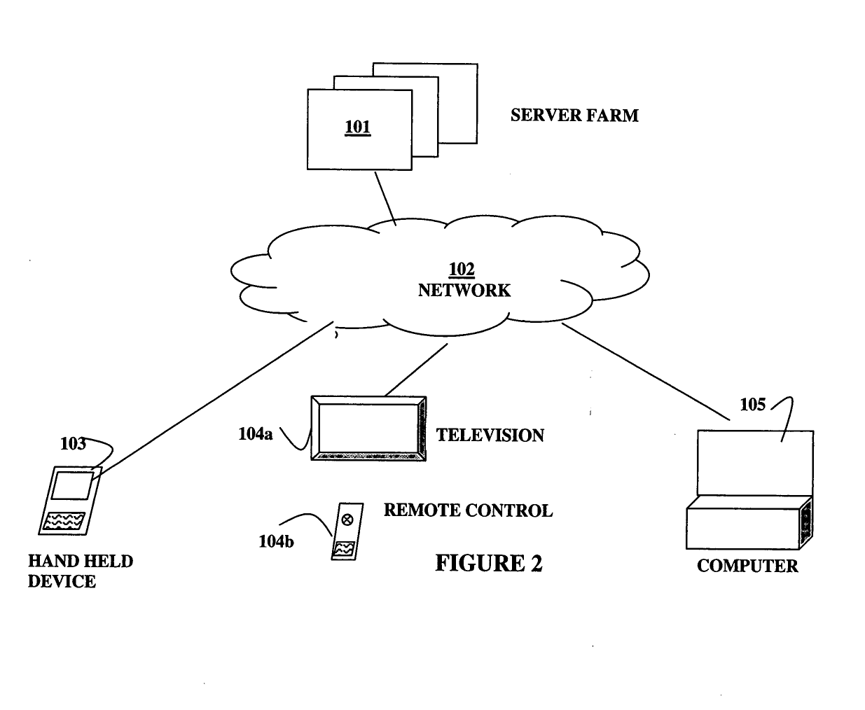

FIG. 2 schematically illustrates an overall system for performing clip sharing using a wide range of devices in accordance with one or more embodiments of the invention. A server farm 101 can serve as the centre for coordinating a group viewing experience with a network 102 functioning as the distribution framework. In one or more embodiments of the invention, a peer-to-peer network could be used for distributing the content, and it could be coupled with a central server for the live group viewing experience. The distribution framework could be a combination of wired and wireless connections. Examples of possible networks include cable television networks, satellite television networks, IP-based television networks, wireless and wired phone networks. The devices could have a wide range of interface capabilities such as a hand-held device 103 (e.g., a phone or PDA) with limited display size and overloaded or small QWERTY or other keypad, a television 104a coupled with a remote control device 104b having an overloaded or small QWERTY or other keypad (e.g., of the type shown in FIG. 1), and a Personal Computer (PC) 105 with a full QWERTY or other keyboard and a computer display.

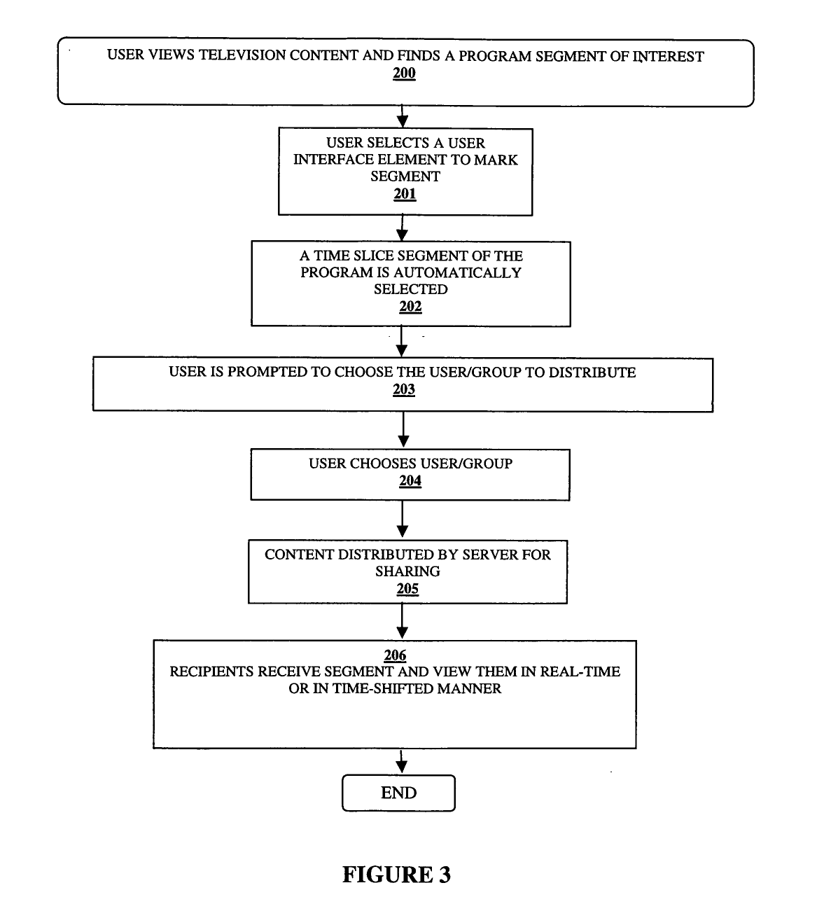

FIG. 3 illustrates an exemplary process flow in accordance with one or more embodiments of the invention. At step 200, a user views a program segment and finds a program or program segment of interest. At step 201, the user then selects, using an interface element (such as a remote control button, or a soft button displayed on the screen), the segment of interest. This action can make the system automatically select at 202 a given time segment that precedes and/or follows the time point where user expressed the intent to mark the segment. The system then prompts the user at 203 to select other users or groups of users to which the clip is to be distributed. The user creates the distribution list at 204, e.g., from a displayed list of users and groups. In one or more embodiments of the invention, the central server farm 101 distributes the clip at 205 to the distribution list. The distribution may be a link of the segment or an actual copy of the segment. In another embodiment of the invention, the clip could be sent as a physical copy of the segment. The size of the clip segment may be determined by, e.g., any copyright or business rules for that content. The recipients would receive a notification of the receipt of the clip arrival, and can view/hear the clip at 206. If they are online on receipt of the clip notification, they will be prompted to determine if they would like to participate in the group viewing experience. In one or more embodiments of the invention, a television remote control used with the television includes a microphone, that can be used to talk to, on the press of a button. (Alternatively, a microphone separate from the remote control can be used.) The system would use the conventional methods of group conferencing to enable speaker floor access and release. If the user is not online, then they can view the content at a later time, at which point, the content and the group conversations that transpired can be seen. This experience enables a user to experience a virtual living room experience that happened in the past.

The content segment can also be annotated in a time-shifted manner where the annotation could be web-based. The system thus enables multiple annotation sources for a program in contrast to a single choice of listening to the commentary that is broadcast with the program.

The real-time annotation using the press-and-hold interface for the microphone on the remote control can serve a number of purposes including (1) the microphone is only turned on in the short interval when user speaks, so it does not pick up the ambient noise, including the audio from the television program (2) the press-action that switches on the microphone, can also serve as a trigger to turn down the television audio on both the speaker and the recipient end. The recipient has the prerogative to set his preferences, such as muting/lowering the television audio when group members speak etc. In another embodiment the, toggling the recording state can be done by a “send/end” action as opposed to a press-and-hold interface.

The viewing/hearing of the clip may be governed by business rules. These business rules can include, e.g., allowing a recipient to view/hear the clip for free, but requiring payment to view/hear the entire clip. In another instance, the sender may have purchased the content so the recipient can view/hear it directly.

While the embodiments described here illustrate television as the medium for initiating the sharing, it could also be a phone or a mobile device. The methods described in accordance with various embodiments of the invention, enable a user, while engaging in a viewing/hearing experience such a watching a television show or listening to a downloaded music or video clip on a phone, to generally seamlessly engage in a living room like experience in sharing the segment with other users.

The invention may be embodied in other specific forms without departing from the spirit or essential characteristics thereof. The embodiments described herein are therefore to be considered in respects as illustrative and not restrictive, the scope of the invention being indicated by the appended claims rather than by the foregoing description, and all changes which come within the meaning and range of the equivalency of the claims are therefore intended to be embraced therein. Method claims set forth below having steps that are numbered or designated by letters should not be considered to be necessarily limited to the particular order in which the steps are recited.

1. A method of sharing a content viewing or listening experience, the method comprising:
(a) identifying content of interest;
(b) selecting a time slice segment of the content;
(c) identifying a content recipient;
(d) transmitting the segment of the content to the content recipient; and
(e) engaging in a live or time-shifted conversation with the content recipient.

2. The method of claim 1 wherein transmitting the segment comprises transmitting the segment or a link to the segment.

3. The method of claim 1 further comprising sending an annotation of the segment to the recipient.

4. The method of claim 1 wherein steps (b) and (c) are performed using a television remote control device.

5. The method of claim 1 wherein the content comprises a video or music content.

6. The method of claim 1 further comprising bookmarking content of interest for later distribution to a recipient.

7. The method of claim 1 wherein the distribution of the content is governed by business rules associated with the content.

8. The method of claim 1 wherein the device used for sharing the content is a television or a mobile device.
